(19) United States
(12) Patent Application Publication
(10) Pub. No.: US 2015/0353759 A1
(43) Pub. Date: Dec. 10, 2015

(54) Packaging Coating Composition

(71) Applicant: PPG PACKAGING COATINGS (SUZHOU) CO., LTD., Jiangsu (CN)

(72) Inventors: Yan Xin, Jiangsu (CN); Yanhui Li, Jiangsu (CN); Zhiping Wang, Jiangsu (CN)

(21) Appl. No.: 14/760,114

(22) PCT Filed: Jan. 9, 2014
(86) PCT No.: PCT/CN2014/070380

§ 371 Date: Jul. 9, 2015

(30) Foreign Application Priority Data
Jan. 9, 2013 (CN) 201310007802.0

(51) Int. Cl. C09D 133/26; C09D 125/14

(52) U.S. Cl. CPC C09D 133/26; C09D 125/14

(57) ABSTRACT

The present invention relates to a coating composition for a package, especially a coating composition for a food and/or beverage package, wherein the coating composition comprises (1) a first acrylic resin comprising acrylic acid, alkyl acrylate and styrene; (2) a second acrylic resin comprising N-butoxy methyl acrylamide. Coating systems comprising two or more such coating layers are also disclosed.

### FIELD OF THE INVENTION

The present invention relates to a packaging coating composition, especially a packaging coating composition for food and/or beverage containers. The packaging coating composition comprises a) a first acrylic resin comprising acrylic acid, alkyl acrylate and styrene; b) a second acrylic resin comprising N-butoxy methyl acrylamide.

### BACKGROUND OF THE INVENTION

In modern life, a variety of coatings are applied on the surface of food and beverage packages to form a protective coating. For example, coil coating and/or sheet coating are usually used to apply the coating on the metal container or the material from which the container will be fabricated. The coil coating and/or sheet coating refer to a process for coating coil or sheet substrates including stainless steel, tin plated steel, or aluminum substrates with an appropriate composition. Then, the coated substrate can be manufactured into a can body, bottom, lid, and/or cover. In addition, the coating composition also can be applied onto an already formed can body, bottom, lid and/or cover such as by spray coating and/or dip coating the part, and then curing. The coating for food and beverage packages usually can be applied on the substrate at high speed, while also providing necessary performance to meet the needs of end users, for example, the formed coating layer should be safe for contacting with food and beverage, and/or have excellent adhesion to the substrate.

In the process for manufacturing “easy-open” cans, a necking step will bend the substrate. Depending on the coating layer and the process used, the cured coating may crack during the bending procedure, resulting in a defects. Accordingly, there is demand for novel coating compositions with better flexibility, maintaining the coating layer integrity without cracking during the necking proceduring, to meet the requirements for can production.

Many of the coating compositions for food and beverage containers are based on epoxy resins that are based on polyglycidyl ethers of bisphenol A. Bisphenol A in packaging coatings either as bisphenol A itself (BPA), derivatives thereof, such as diglycidyl ethers of bisphenol A (BADGE), epoxy novolak resins and polyols prepared with bisphenol A and bisphenol F are problematic. Although the balance of scientific evidence available to date indicates that small trace amounts of BPA or BADGE that might be released from existing coatings does not pose health risks to humans, these compounds are nevertheless perceived by some as being harmful to human health. Consequently, there is a strong desire to eliminate these compounds from coatings for food and beverage containers. Accordingly, packaging coating compositions for food or beverage containers that do not contain extractable quantities of BPA, BADGE or other derivatives of BPA and yet have suitable properties for use in this application are therefore desired.

### SUMMARY OF THE INVENTION

The present invention provides a coating composition comprising:

a) a first acrylic resin comprising acrylic acid, alkyl acrylate and styrene;

b) a second acrylic resin comprising N-butoxy methyl acrylamide.

The present invention further provides a coating system comprising a basecoat layer, and a topcoat layer, wherein the basecoat layer comprises the coating composition of the present invention comprising a first acrylic resin and a second acrylic resin, and the topcoat layer comprises the coating composition of the present invention comprising a first acrylic resin and a second acrylic resin.

Methods for coating packages, and packages coated thereby are also within the scope of the invention.

### DETAILED DESCRIPTION OF THE INVENTION

The present invention provides a coating composition comprising: a) a first acrylic resin comprising acrylic acid, alkyl acrylate and styrene; b) a second acrylic resin comprising N-butoxy methyl acrylamide. In certain embodiments, the coating composition of the present invention further comprises a crosslinker. In certain embodiments, the coating compostion of the present invention further comprises a colorant, such as a pigment.

As noted above, the present invention also provides a coating system comprising a basecoat layer and a topcoat layer, wherein the basecoat and topcoat both comprise a) a first acrylic resin comprising acrylic acid, alkyl acrylate and styrene; and b) a second acrylic resin comprising N-butoxy methyl acrylamide. The first and/or second acrylic resin used in the basecoat can be the same or different as the first and/or second acrylic resin used in the topcoat. In certain embodiments an ink layer may be used between the basecoat and topcoat. The ink layer can substantially cover the basecoat, or can be applied in a particular pattern, such as to impart words and/or images onto the basecoat (and underlying substrate). The ink can be used in the present application are these commonly commercially available for ink for two Piece can, including these provided by INX.

Acrylic resins according to the present invention including both the first acrylic resin and the second acrylic resin according to the present invention can generally include a polymer derived from acrylic or methacrylic monomers. Furthermore, blends of acrylic polymers derived from acrylic or methacrylic monomers can be used. Suitable monomers include but are not limited to: acrylic acid, methyl acrylate, ethyl acrylate, propyl acrylate, butyl acrylate, pentyl acrylate, hexyl acrylate, methyl methacrylate, methyl methacrylate, ethyl methacrylate, propyl methacrylate, butyl methacrylate, pentyl methacrylate, hexyl acrylate, acrylamide, N-methylol acrylamide, N-butoxy methacrylamide, and/or N-isobutoxy methacrylamide, or mixtures thereof. The acrylic polymer may also contain hydroxyl groups that are typically derived from hydroxy-substituted acrylic or methacrylic esters. Examples include hydroxyethyl acrylate, hydroxypropyl acrylate, hydroxybutyl acrylate, hydroxyethyl methacrylate, hydroxypropyl methacrylate and/or hydroxybutyl methacrylate and the like. The acrylic polymer can be also copolymers or polymer mixtures derived from acrylic or methacrylic monomers with other polymerizable monomers. The other polymerizable monomers include styrene, acrylonitrile and the like which are commonly used in the art. The weight average molecular weight (MW) of the acrylic polymer component can be at least 5,000 g/mol, such as 15,000 to 100,000 g/mol. The acrylic polymer typically has an acid value of 70 to 110 mg KOH/g, such as 80 to 100 mg KOH/g; a hydroxyl value of 10 to 40 mg KOH/g, such as 20 to 30 mg KOH/g; and a glass transition temperature (Tg) of −20 to +100° C., such as +20 to +70° C.

In certain embodiments, the coating composition of the invention comprises a first acrylic resin and a second acrylic resin.

In certain embodiments, the first acrylic resin comprises acrylic acid, alkyl acrylate and styrene.

In certain embodiments, the first acrylic resin comprises one or more alkyl acrylates, each of which may optionally comprise a hydroxyl functional group. The alkyl acrylate can comprise, for example, ethyl acrylate, propyl acrylate, and/or butyl acrylate, with butyl acrylate being particularly suitable. The alkyl acrylate comprising a hydroxyl group can comprise, for example, hydroxyethyl acrylate, hydroxypropyl acrylate, hydroxyethyl methacrylate and hydroxypropyl methacrylate, with hydroxyethyl methacrylate being particularly suitable.

In certain embodiments, based on the total weight of the first acrylic resin, acrylic acid is present in an amount of about 1 to 30 wt %, such as about 5 to 20 wt %, or about 8 to 15 wt %; styrene is present in an amount of about 10 to 40 wt %, such as about 15 to 35 wt %, or about 20 to 30 wt %.

In certain embodiments, based on the total weight of the first acrylic resin, butyl acrylate is present in an amount of about 20 to 80 wt %, such as 30 to 70 wt %, or 40 to 60 wt %; with hydroxyethyl acrylate present in an amount of 2 to 20 wt %, such as 5 to 15 wt %, or 8 to 12 wt %.

In certain embodiments, the second acrylic resin comprises N-butoxy methyl acrylamide.

In certain embodiments, the second acrylic resin further comprises one or more acrylic monomers including but not limited to: acrylic acid, methyl acrylate, ethyl acrylate, propyl acrylate, butyl acrylate, methyl methacrylate, methyl methacrylate, ethyl methacrylate, propyl methacrylate, butyl acrylate, hydroxy methyl acrylate, hydroxy ethyl acrylate, hydroxy propyl acrylate and/or hydroxy butyl acrylate.

In certain embodiments, the second acrylic resin further comprises styrene.

In certain embodiments, the second acrylic resin further comprises an initiator.

In certain embodiments, based on the total weight of the second acrylic resin, N-butoxymethyl acrylamide is present in an amount of 5 to 40 wt %, such as 10 to 30 wt %, or 15 to 20 wt %.

In certain embodiments, in the coating composition of the present invention, based on the total weight of the coating composition, the first acrylic resin is present in an amount of 5 to 50 wt %, such as 15 to 40 wt %, 20 to 35 wt %, or 25 to 30 wt %; the second acrylic resin is present in an amount of 5 to 45 wt %, such as 10 to 40 wt %, 15 to 35 wt %, or 20 to 30 wt %.

In certain embodiments, in the coating composition of the present invention, the ratio of the first acrylic acid and second acrylic resin is 1.0:0.2 to 1.0:1.0.

In certain embodiments, the coating composition of the present invention further comprises a crosslinker. A crosslinker particularly suitable for the coating composition of the present invention include benzoguanamine crosslinkers. These agents can be commercially available, such as Cytec CYMEL products, including CYMEL 659 and CYMEL 1123. Typically, when presents, based on the total weight of the coating composition, the crosslinker is present in an amount of 2 to 30 wt %, such as 2 to 8 wt %, or 2 to 4 wt %, or 10 to 25 wt %, or 15 to 20 wt %. The coating composition of the present invention may use one or more crosslinkers. Suitable crosslinkers are selected depending on the chemical nature of the polymer resin, and it is within the ability of the skilled person in the art to select one or more crosslinking agents.

Optional ingredients can be included in the coating composition. Typically, the coating composition will contain a diluent, such as water, or an organic solvent or a mixture of water and organic solvent to dissolve or disperse the resinous binder. The diluent may be reactive or unreactive or mixtures thereof. In certain embodiments, the organic solvent is selected to have sufficient volatility to evaporate essentially entirely from the coating composition during the curing process such as during heating from 175-205° C. for about 5 to 15 minutes. Examples of suitable organic solvents are aliphatic hydrocarbons such as mineral spirits and high flash point VM&P naphtha; aromatic hydrocarbons such as benzene, toluene, xylene and solvent naphtha 100, 150, 200 and the like; alcohols, for example, ethanol, n-propanol, isopropanol, n-butanol and the like; ketones such as acetone, cyclohexanone, methylisobutyl ketone and the like; esters such as ethyl acetate, butyl acetate, and the like; glycols such as butyl glycol, glycol ethers such as methoxypropanol and ethylene glycol monomethyl ether and ethylene glycol monobutyl ether and the like. Mixtures of various organic solvents can also be used. When present, the diluent is used in the coating compositions in amounts of about 5 to 40 wt %, such as 10 to 30 wt %, or 15 to 25 wt % based on total weight of the coating composition.

Another optional ingredient is a catalyst to increase the curing or crosslinking rate of the coating composition. Generally an acid catalyst can be used. In embodiments, the solvent borne coating composition of the present invention, based on its total weight, comprises 0.05 to 5 wt %, such as 0.5 to 2 wt % of a catalyst. Examples of suitable catalysts include dodecylbenzenesulfonic acid, methanesulfonic acid, p-toluenesulfonic acid, dinonyl naphthalene disulfonic acid and phenyl phosphonic acid.

Another useful optional ingredient is a lubricant, for example, a wax, which facilitates manufacture of metal closures by imparting lubricity to the sheets of the coated metal substrate. Suitable lubricants include, for example, carnauba wax FLUOROSLIP FS731MG wax, MPP-620F, SST-3H wax, Carnauba wax, T-1, SP 96 microcrystalline wax and polyethylene-type lubricants. If used, the lubricant can be used in the coating compositions of at least 0.1 wt % based on total weight of the coating composition.

Yet another useful optional ingredient is a surfactant. Surfactants can optionally be added to the coating composition to aid in flow and wetting of the substrate. Examples of suitable surfactants include, but are not limited to, non ionic surfactants such as the reaction products of alkylene oxides and alkyl substituted phenols, for example, ethoxalated nonyl phenol polyether. If used, the surfactant is typically present in amounts of at least 0.01 wt % and no greater than 10 wt % based on the total weight of the coating composition.

The coating compositions of the present invention can also comprise any additives standard in the art of coating manufacture including colorants, plasticizers, abrasion-resistant particles, film strengthening particles, flow control agents, thixotropic agents, rheology modifiers, catalysts, antioxidants, biocides, defoamers, surfactants, wetting agents, dispersing aids, adhesion promoters, clays, hindered amine light stabilizers, UV light absorbers and stabilizers, a stabilizing agent, fillers, grind vehicles, and other customary auxiliaries, or combinations thereof. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art. When present, the colorant is used in the coating compositions in amounts of about 10 to 40 wt %, such as 15 to 35 wt %, or 20 to 30 wt %, based on total weight of the coating composition.

In certain embodiments, the coating composition of the present invention, may be substantially free, may be essentially free and/or may be completely free of bisphenol A and derivatives or residues thereof, including bisphenol A (“BPA”) and bisphenol A diglycidyl ether (“BADGE”). Such compositions and/or coatings are sometimes referred to as “BPA non intent” because BPA, including derivatives or residues thereof, are not intentionally added but may be present in trace amounts because of impurities or unavoidable contamination from the environment. The compositions and/or coatings can also be substantially free and may be essentially free and/or may be completely free of bisphenol F and derivatives or residues thereof, including bisphenol F and bisphenol F diglycidyl ether (“BFDGE”). The term “substantially free” as used in this context means the compositions and/or coatings contain less than 1000 parts per million (ppm), “essentially free” means less than 100 ppm and “completely free” means less than 20 parts per billion (ppb) of any of the above mentioned compounds, derivatives or residues thereof.

The coating composition of the present invention can be applied to any substrates known in the art, for example, automotive substrates, industrial substrates, packaging substrates, architectural substrates, wood flooring and furniture, apparel, electronics including housings and circuit boards, glass and transparencies, sports equipment including golf balls, and the like. These substrates can be, for example, metallic or non-metallic. Metallic substrates include tin, steel, tin-plated steel, tin free steel, black plate, chromium passivated steel, galvanized steel, aluminum, aluminum foil. Non-metallic substrates include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (“PET”), polycarbonate, polycarbonate acrylobutadiene styrene (“PC/ABS”), polyamide, wood, veneer, wood composite, particle board, medium density fiberboard, cement, stone, glass, paper, cardboard, textiles, leather both synthetic and natural, and other nonmetallic substrates. The substrate can be one that has been already treated in some manner, such as to impart visual and/or color effect.

The coating composition of the present invention can be applied by any means standard in the art, such as electrocoating, spraying, electrostatic spraying, dipping, rolling, brushing, and the like.

The coating composition of the present invention can be applied in certain embodiments to a dry film thickness of about 1 to 100 microns (about 0.04 to 4 mils), such as about 8 to 50 microns (about 0.3 to 2 mils) or about 18 to 33 microns (about 0.7 to 1.3 mils). In certain embodiments, the coating compositions of the present invention can be applied to a dry film thickness of about 2.5 microns (about 0.1 mils) or greater, about 13 microns (0.5 mils) or greater, about 25 microns (1.0 mils) or greater, about 50 microns (2.0 mils) thick or less, about 125 microns (5.0 mils) thick or less, about 250 microns (5.0 mils) or greater.

The coating composition of the present invention can be used alone, or in combination with one or more other coatings. For example, the coating composition of the present invention can comprise a colorant or not and can be used as a primer, basecoat, and/or topcoat. For substrates coated with multiple coatings, one or more of those coatings can be coatings as described herein.

The coating composition of the present invention is also suitable for use as packaging coatings. The application of various pretreatments and coatings to packaging is well established. Such treatments and/or coatings, for example, can be used in the case of metal cans, wherein the treatment and/or coating is used to retard or inhibit corrosion, provide a decorative coating, provide ease of handling during the manufacturing process, and the like. Coatings can be applied to the interior of such cans to prevent the contents from contacting the metal of the container. Contact between the metal and a food or beverage, for example, can lead to corrosion of a metal container, which can then contaminate the food or beverage. This is particularly true when the contents of the can are acidic in nature. The coatings applied to the interior of metal cans also help prevent corrosion in the headspace of the cans, which is the area between the fill line of the product and the can lid; corrosion in the headspace is particularly problematic with food products having a high salt content. Coatings can also be applied to the exterior of metal cans. Certain coatings of the present invention are particularly applicable for use with coiled metal stock, such as the coiled metal stock from which the ends of cans are made (“can end stock”), and end caps and closures are made (“cap/closure stock”). Since coatings designed for use on can end stock and cap/closure stock are typically applied prior to the piece being cut and stamped out of the coiled metal stock, they are typically flexible and extensible. For example, such stock is typically coated on both sides. Thereafter, the coated metal stock is punched. For can ends, the metal is then scored for the “pop-top” opening and the pop-top ring is then attached with a pin that is separately fabricated. The end is then attached to the can body by an edge rolling process. A similar procedure is done for “easy open” can ends. For easy open can ends, a score substantially around the perimeter of the lid allows for easy opening or removing of the lid from the can, typically by means of a pull tab. For caps and closures, the cap/closure stock is typically coated, such as by roll coating, and the cap or closure stamped out of the stock; it is possible, however, to coat the cap/closure after formation. Coatings for cans subjected to relatively stringent temperature and/or pressure requirements should also be resistant to popping, corrosion, blushing and/or blistering.

Accordingly, the present invention is further directed to a package coated at least in part with any of the coating compositions described above. In certain embodiments, the package is a metal can. The term “metal can” includes any type of metal can, container or any type of receptacle or portion thereof used to hold something. One example of a metal can is a food can; the term “food can(s)” is used herein to refer to cans, containers or any type of receptacle or portion thereof used to hold any type of food and/or beverage. Thus a “food can” includes a “beverage can”. The term “metal can(s)” specifically includes food cans and also specifically includes “can ends”, which are typically stamped from can end stock and used in conjunction with the packaging of foods and beverages. The term “metal cans” also specifically includes metal caps and/or closures such as bottle caps, screw top caps and lids of any size, lug caps, and the like. Metal cans can be used to hold other items as well as food and/or beverage, including but not limited to personal care products, bug spray, spray paint, and any other compound suitable for packaging in an aerosol can. The cans can include “two piece cans” and “three-piece cans” as well as drawn and ironed one-piece cans; such one piece cans often find application with aerosol products. Packages coated according to the present invention can also include plastic bottles, plastic tubes, laminates and flexible packaging, such as those made from PE, PP, PET and the like. Such packaging could hold, for example, food, toothpaste, personal care products and the like.

The coating composition of the present invention can be applied to the interior and/or the exterior of the package. For example, the coating can be rollcoated onto metal used to make three-piece can bodies, two- or three-piece can end stock and/or cap/closure stock. In some embodiments, the coating is applied to a coil or sheet by roll coating; the coating is then cured by radiation and can ends are stamped out and fabricated into the finished product, i.e. can ends. In other embodiments, the coating is applied as a rim coat to the bottom of the can; such application can be by roll coating. The rim coat functions to reduce friction for improved handling during the continued fabrication and/or processing of the can. In certain embodiments, the coating is applied to caps and/or closures; such application can include, for example, a protective varnish that is applied before and/or after formation of the cap/closure and/or a pigmented enamel post applied to the cap, particularly those having a scored seam at the bottom of the cap. Decorated can stock can also be partially coated externally with the coating described herein, and the decorated, coated can stock used to form various metal cans.

For purposes of this description, it is to be understood that the invention may assume various alternative variations and step sequences, except where expressly specified to the contrary. Moreover, other than in any operating examples, or where otherwise indicated, all numbers expressing values, ranges, amounts or percentages, for example, quantities of ingredients, used in the specification and claims may be read as if prefaced and as being modified in all instances by the term “about,” even if the term does not expressly appear. Also, it should be understood that any numerical range recited herein is intended to include the endpoints of those ranges and all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used in this specification and the appended claims, singular encompasses plural and vice versa, unless specifically stated otherwise. For example, although reference is made herein to the articles “a,” “an,” and “the,” plural referents are included unless expressly and unequivocally limited to one referent. For example, although reference is made herein to “an” acrylic acid, “an” alkyl acrylate, “a” crosslinker and the like, one or more of each of these components, and of any other components, can be used. In addition, in this application, the use of “or” means “and/or” unless specifically stated otherwise, even though “and/or” may be explicitly used in certain instances. “Including,” “for example,” “such as” and like terms means including, for example, such as, but not limited to.

The various embodiments and examples of the present invention as presented herein are each understood to be non-limiting with respect to the scope of the invention.

The invention will be further described by reference to the following examples. The following examples are merely illustrative of the invention and are not intended to be limiting.

### EXAMPLES

The following examples are presented to demonstrate the general principles of the invention. The Examples describe the preparation of solvent borne alkyd resin and solvent borne coating composition according to embodiments of the present invention and methods of preparation. All amounts listed are described in parts by total weight, unless otherwise indicated. The invention should not be construed as limited to the specific examples presented.

### Example 1

### Synthesis of the First Acrylic Resin

12 grams of acrylic acid, 10 grams of hydroxyethyl acrylate, 56 grams of butyl acrylate and 22 grams of styrene were added to a flask while stirring at room temperature, heated to reflux for 6 hrs, cooled to room temperature, then stored for further use.

### Example 2

### Synthesis of the Second Acrylic Resin

18 grams of N-butoxymethyl acrylamide, 12 grams of acrylic acid, 24 grams of butyl acrylate, 16 grams of methyl methacrylate, 6 grams of butyl methacrylate, 20 grams of microcrystalline wax, and 4 grams of t-butyl peroxy benzoate were added to a flask while stiffing at room temperature, then heated to reflux. Acid value and hydroxyl value were checked until the acid value reached 90 mg KOH/g, and the hydroxyl value reached 25 mg KOH/g. Once the acid value and hydroxyl value were within the range, stopped stirring then stored for further use.

### Example 3

### Synthesis of the Coating Composition

The coating composition was prepared according to the following formula, based on the total weight of the coating composition:

| | | | Coating | Coating |
|---|---|---|---|---|
| | | | Compostion A | Composition B |
| 1 | Acrylic acid | First acylic acid | 30 | 42 |
| 2 | | Second acrylic acid | 25 | 10 |
| 3 | Crosslinker | CYMEL 659 | 18 | |
| | | CYMEL 1123 | | 17 |
| 4 | Deforming | BYK 019 | 1 | 1 |
| | agent | | | |
| 5 | Wax | FLUOROSLIP | 1 | 1 |
| | | FS731MG wax | | |
| 6 | Water | Deionized water | 2 | 5 |
| 7 | Solvent | N-butanol | 23 | 24 |

### Example 4

### Preparation and Test for the Coating

A #8 spatula was used for sampling, corresponding to 4.2 grams of dry weight per square meter.

2P white aluminum cans were flatterned, and wiped with butanone to remove impurities. A certain amount of ink was roller coated on the substrate, wherein the ink can be red/black/blue/yellow ink, and then the coating compositions A and B prepared in Example 3 were applied on the ink layer with a #8 spatula.

The coated 2P white aluminum cans were placed in a oven and baked for 25 seconds at 195° C., then raised to 205° C. and continued to bake for 2 minutes, then the sample was removed from the oven for further testing.

Test Method

A. Butanone Resistance

A hammer weighted about 1 kg was wrapped in absorbent cotton, and then further wrapped in cotton cloth. The absorbent cotton and cotton cloth were wetted with butanone. The hammer was dragged by hand to slide on the baked samples back and forth. Each ture of back and forth was counted as 1 time. Counting the times the hammer sliding back and forth until the surface of the sample was broken. Then the number of times was recorded as butanone resistance number.

B. Gloss

The gloss is tested with a glossmeter by recording the data read at an angle of 60 degrees.

C. Ink Wettability

The ink wettability was visually measured by naked eyes. A full colored surface without defects was ranked as excellent.

D. Adhesion

Adhesion was tested by a grid method. The grid method comprises drawing 10×10 grids on surface of the coating, then trying to peel off the grip with 3M 610 tape. 100% of the grids were still adhered was ranked as excellent.

E. Sterilization Performance at High Temperature

The baked samples were placed into a high-temperature sterilizer, and heated to a sterilization temperature of 121° C. for 30 minutes until the pressure decreased to atmosphere pressure. The samples were removed for test. The sterilizing medium is steam or tap water.

Test Results

Samples without Sterilization

| | Coating composition A | Coating composition B |
|---|---|---|
| Apperance | Good | Good |
| Butonone Resistance | >200 | 100-180 |
| Gloss | 96 | 93 |
| Ink wettability | Good | Good |
| Adhension, Grid Method | 100% Not peeled off | 100% Not peeled off |
| Pencil Hardness | 5H | 5H |
| (room temperature) | | |

Samples Sterilized with Steam

| | Coating composition A | Coating composition B |
|---|---|---|
| Apperance | No Blushing and | No Blushing and |
| | Bubbling | Bubbling |
| Butonone Resistance | 7-8 | 5-6 |
| Gloss | 90 | 84 |
| Adhension, Grid Method | 100% Not peeled off | 100% Not peeled off |
| Pencil Hardness | 4H | 3H |
| (room temperature) | | |

Samples Sterilized with Tap Water

| | Coating composition A | Coating composition B |
|---|---|---|
| Apperance | No Blushing and | No Blushing and |
| | Bubbling | Bubbling |
| Butonone Resistance | 7-8 | 5-6 |
| Gloss | 90 | 84 |
| Adhension, Grid Method | 100% Not peeled off | 100% Not peeled off |
| Pencil Hardness | 4H | 3H |
| (room temperature) | | |

### Example 5

### Synthesis of the Coating Composition

The coating composition was prepared according to the following formula, based on the total weight of the coating composition:

| | | | Coating Composition C |
|---|---|---|---|
| 1 | Acrylic acid | First acylic acid | 43 |
| 2 | | Second acrylic acid | 10 |
| 3 | Crosslinker | CYMEL 659 | 2 |
| 4 | Pigment | Tiona 595 pigment | 24 |
| 5 | Deforming | CoatOsil 7500 | 1 |
| | agent | COPOLYMER | |
| 6 | Wax | MPP-620F | 1 |
| 7 | Water | Deionized water | 2 |
| 8 | Solvent | N-butanol | 17 |

### Example 6

### Preparation and Test for the Coating

Coating Preparation

A. Applying Basecoat

2P white aluminum cans were flatterned, and wiped with butanone to remove impurities. A #10 spatula was used for applying the coating composition C prepared in Example 4, corresponding to 6.0 grams of dry weight per square meter. The coated 2P white aluminum cans were placed in a oven and baked for 25 seconds at 195° C., then removed from the oven to cool down to room temperature.

B. Applying Ink

A certain amount of ink was roller coated on the cured basecoat, wherein the ink can be red/black/blue/yellow ink.

C. Applying Topcoat

The coating compositions A and B prepared in Example 3 were applied on the ink layer with a #8 spatula, corresponding to 4.2 grams of dry weight per square meter.

The coated 2P white aluminum cans were placed in a oven and baked for 25 seconds at 195° C., then raised to 205° C. and continued to bake for 2 minutes, then the sample was removed from the oven for further testing.

Test Method

The following properties were tested in accordance with the test procedure described above, including A. Butanone Resistance, B. Gloss, C. Ink wettability, D. Adhesion and E. Sterilization performance at high temperature.

F. Flexibility

The coated substrate samples were modeled in a 206 mould to mimic the necking procedure in can manufacture. And observe if the coating was peeled off at the point where the substrate was maximum distorted by using 3M 610 tape. It will be ranked as excellent if there is no coating peeled off, or ranked as acceptable if the coating is slightly peeled off.

Test Results

Samples without Sterilization

| | | |
|---|---|---|
| Basecoat | Coating composition C | Coating composition C |
| Topcoat | Coating composition A | Coating composition B |
| Apperance | Good | Good |
| Butonone Resistance | >200 | 100-180 |
| Gloss | 96 | 93 |
| Ink wettability | Good | Good |
| Adhension, Grid Method | 100% Not peeled off | 100% Not peeled off |
| Pencil Hardness | 5H | 5H |
| (room temperature) | | |
| Flexiblity | No peeled off | Slightly peeled off |

Samples Sterilized with Steam

| | | |
|---|---|---|
| Basecoat | Coating composition C | Coating composition C |
| Topcoat | Coating composition A | Coating composition B |
| Apperance | No Blushing and | No Blushing and |
| | Bubbling | Bubbling |
| Butonone Resistance | 7-8 | 5-6 |
| Gloss | 90 | 84 |
| Adhension, Grid Method | 100% Not peeled off | 100% Not peeled off |
| Pencil Hardness | 4H | 3H |
| (room temperature) | | |
| Flexiblity | No peeled off | Slightly peeled off |

Samples Sterilized with Tap Water

| | Coating composition A | Coating composition B |
|---|---|---|
| Apperance | No Blushing and | No Blushing and |
| | Bubbling | Bubbling |
| Butonone Resistance | 7-8 | 5-6 |
| Gloss | 90 | 84 |
| Adhension, Grid Method | 100% Not peeled off | 100% Not peeled off |
| Pencil Hardness | 4H | 3H |
| (room temperature) | | |
| Flexiblity | No peeled off | Slightly peeled off |

The results show that the coating layer formed by the coating composition of the present invention has excellent gloss, resistance to wiping, ink adhesion, resistance to high temperature antibacterial treatment, and flexibility, and will satisfy the requirement for necking step during can manufacture, thus the coating composition of the present invention is suitable for metal cans, especially metal food and beverage cans. Whereas particular embodiments of this invention have been described above for purposes of illustration, it will be evident to those skilled in the art that numerous variations of the details of the present invention may be made without departing from the invention as defined in the appended claims. It is understood, therefore, that this invention is not limited to the particular embodiments disclosed, but it is intended to cover modifications that are within the spirit and scope of the invention, as defined by the appended claims.

1. A coating composition comprising:
(1) a first acrylic resin comprising acrylic acid, alkyl acrylate and styrene;
(2) a second acrylic resin comprising N-butoxy methyl acrylamide.

2. The coating composition of claim 1, wherein the first acrylic resin comprises one or more alkyl acrylates, each of which may optionally comprise hydroxyl functionality.

3. The coating composition of claim 2, wherein the alkyl acrylates comprise hydroxyethyl acrylate and butyl acrylate.

4. The coating composition of claim 1, wherein the second acrylic resin comprises 5 to 40 wt % NBMA based on the total weight of the second acrylic resin.

5. The coating composition of claim 1, wherein the second acrylic resin has an acid value of 70 to 110 mg KOH/g and a hydroxyl value of 10 to 40 mg KOH/g.

6. The coating composition of claim 5, wherein the second acrylic resin has an acid value of 80 to 100 mg KOH/g.

7. The coating composition of claim 5, wherein the second acrylic resin has a hydroxyl value of 20 to 30 mg KOH/g.

8. The coating composition of claim 1, wherein the first acrylic resin and the second acrylic resin are present in a ratio from 1.0:0.2 to 1.0:1.0.

9. The coating composition of claim 1 further comprising a crosslinker.

10. The coating composition of claim 9, wherein the crosslinker comprises benzoguanamine.

11. The coating composition of claim 1 further comprising a colorant.

12. The coating composition of claim 1, wherein the composition is substantially free of bisphenol A and derivatives thereof.

13. The coating composition of claim 1, wherein the composition is waterbased.

14. A coating composition comprising, based on total weight of the coating composition:
(1) a mixture of acrylic resins in an amount of 40 to 60 wt %, comprising:
(a) a first acrylic resin comprising acrylic acid, alkyl acrylate and styrene;
(b) a second acrylic resin comprising N-butoxy methyl acrylamide; and
(2) crosslinker in an amount of 10 to 20 wt %.

15. A coating system comprising a basecoat layer and a topcoat layer, wherein the basecoat layer comprises the coating compostion of claim 11, and the topcoat comprises the coating composition of claim 1.

16. The coating system of claim 15, further comprising an ink layer between the basecoat layer and the topcoat layer.

17. A package wherein the coating composition of claim 1 or claim 14, or the coating system of claim 15 or claim 16 is applied to at least a portion of the package.

18. The package of claim 17, wherein the package comprises a food can.

19. A method for coating a package, comprising applying the coating composition of claim 1 or 14, or the coating system of claim 15 or claim 16 to at least a portion of the package.
